(19) United States
(12) Patent Application Publication
(10) Pub. No.: US 2019/0074642 A1
(43) Pub. Date: Mar. 7, 2019

(54) HF Plug and Mounting Wall

(71) Applicant: Kathrein Werke KG, Rosenheim (DE)

(72) Inventors: Thomas Haunberger, Rosenheim (DE); Jürgen Hefele, Rosenheim (DE); Sebastian Stohn, Rosenheim (DE); Markus Surma, Rosenheim (DE)

(21) Appl. No.: 15/572,742

(22) PCT Filed: Apr. 13, 2016
(86) PCT No.: PCT/DE2016/100173

§ 371 Date: Nov. 8, 2017

(30) Foreign Application Priority Data
May 8, 2015 (DE) 10 2015 107 226.2

(51) Int. Cl. H01R 13/74; F16B 21/18; H01R 13/707; H01R 13/18; H01R 13/627

(52) U.S. Cl. CPC H01R 13/745; F16B 21/186; H01R 13/6276; H01R 13/18; H01R 13/707

(57) ABSTRACT

Disclosed is an HF plug on a mounting wall of HF subassemblies, comprising an HF plug element that has a fastening collar and is to be plugged into a through-hole located on the mounting wall of the HF subassembly, and a securing element which is in the form of a resilient element and is shaped and designed to be inserted between a connecting zone of the HF plug element and the mounting wall in such a way as to be positioned between the connecting zone and the mounting wall in such a way as to immobilize the HF plug element. Also disclosed is a mounting wall for the HF plug.

The invention relates to an HF plug connector according to patent claim 1 and to a mounting panel for inventive HF plug connectors according to claim 21.

Numerous HF plug connectors, i.e., plug connectors for high-frequency (HF) applications, are used in various designs for antenna technology. Such plug connectors are used to plug one or more HF bushings into through-openings in HF modules in the form of walls, also known as mounting panels for HF modules and embodied as antenna covers, for example, behind which the antenna with all its respective components is arranged. Such an arrangement is common in particular with mobile radio antenna arrays. One main problem in mounting the HF bushing is how to mount it on the cover in such a way that it sits securely. This is important in order to prevent the connection from deteriorating and therefore breaking of the bushing because high forces are acting on it.

FIG. 1 shows a traditional fastening for HF bushings, wherein after insertion of the HF bushing 1 into the through-opening 20 in the antenna cover 2, it is attached from the rear side of the antenna cover 2 by means of a nut 300, for example. The HF bushing is inserted, i.e., plugged, into the through-opening 20 in the antenna cover 2 up to a closing web 12. To attach a nut 300, an area of a fastening neck 11 of the HF bushing 1 must protrude beyond the through-opening in the antenna cover 2 to the bottom side of the antenna cover 2 and it must have a thread (not shown). The nut 300 is screwed onto the thread by means of a tool. In fastening, the closing web 12 acts as a type of washer, thereby enabling a distribution of the force acting through the screwing of the nut 300. One disadvantage of this fastening method is that the nut must be screwed onto the thread accurately, so as not to cause any tilting. Furthermore, it is time-consuming and therefore cost-intensive to produce screw connections. It is often difficult as well, due to a lack of space for using a tool for tightening the screws.

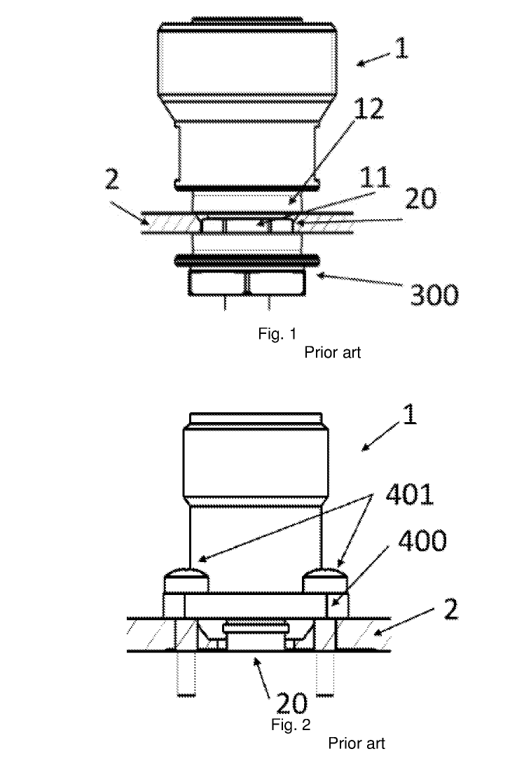

FIG. 2 shows another typical type of fastening for HF bushings 1 on an antenna cover 2, where the HF bushing 1 is attached to a mounting plate 400 that is larger than the through-opening 20 in the antenna cover 2. The mounting plate 400 is attached at the outer ends to the top side of the antenna 2, i.e., to the side facing the HF bushing 1, by means of several screws 401. One disadvantage of this fastening method is that up to four screws must be attached here, which is enormously time-consuming. In addition, a great deal of space is needed due to this mounting plate, which can be a great disadvantage with applications in which several bushings must be mounted in a small amount of space. Furthermore, the cost is increased due to the use of additional components such as screws.

One alternative fastening method is described in DE 102010014154 B4, where a sleeve-shaped connecting piece for accommodating the internal and external conductors of the housing coupler has at least one region, which engages in a form-fitting connection to a housing wall of the electrical/electronic device in at least some sections. The connecting piece of the housing coupler is preferably designed here as an integral part, i.e., in one piece with the housing wall. The inside and/or outside conductors may then be passed through the connecting piece and fastened there.

Another conventional fastening method is the so-called push-pull lock, which is described in the patent specification DE 000004439852 C2, for example, which is no longer pending. However, this fastening method relates to a connection between a bushing and a plug, not to a connection between a bushing and a cover. With this type of connection, it is advantageous that no tool is needed to create a screw connection. However, it is expensive, on one hand, and also does not ensure that the HF bushing is fastened in such a way that it cannot move because this type of lock is not very stable with respect to torsional loads. For this reason as well, a use according to the invention as a connection between a bushing and a cover is not advantageous.

The object of the present invention is therefore to provide an HF plug connector and a mounting panel for inventive plug connectors by means of which the aforementioned problems are overcome. Specifically, an HF plug connector, which can be installed and dismantled easily, is to be made available, establishing a connection between an HF bushing and a mounting panel substantially without any play.

This object is achieved according to the invention by the features of patent claims 1 and 21. Advantageous embodiments are the subject matter of the dependent claims.

What is proposed according to the invention is, on the one hand, an HF plug connector comprising a combination of an HF plug element and an elastic securing element, by means of which attachment of the HF bushing on a mounting panel such as an antenna cover can be achieved without screw connections, and preferably substantially without any play. On the other hand, a mounting panel for an inventive HF plug connector is proposed which achieves this object.

The HF plug element of the HF plug connector according to the invention will first be described in greater detail below. Then the securing element of the HF plug connector according to the invention will be described in detail. Individual exemplary embodiments are explained in greater detail later with reference to the drawings. The description always refers to a single HF plug connector and one through-opening, etc. However, this serves only to illustrate the principle of the invention. If several HF plug connectors are to be arranged on a mounting panel, the invention can be transferred to each individual HF plug connector and each individual through-opening, etc.

HF Plug Element

The HF plug element according to the invention in this exemplary embodiment may be an HF bushing. HF bushings normally consist of a mechanical module, i.e., mainly a mounting panel and an electric module, which is surrounded by the mechanical module and/or is inserted into it and is protected by it. In an alternative exemplary embodiment, the HF plug element may also be simply the electrical module, which is normally in the interior of the mechanical module, i.e., for example, internal conductor and external conductor. The HF plug element is designed as described below.

The HF plug element to be attached like an antenna to the mounting panel of an HF module has, according to the invention, a fastening neck that can be inserted into a through-opening in the mounting panel. In addition, the HF plug element has a connecting region that is plugged onto the securing element. The connecting region is shaped so as to ensure that the securing element can be secured on the HF plug element between the connecting region and the mounting panel. In the first embodiment mentioned above, the securing element and the HF plug connector thus enter into a connection without any play and/or the securing element surrounds the HF plug element without any play. In the second embodiment mentioned above, this connection is not necessarily without play.

The term “without play” is understood to refer to a fixation of the components which does not allow any freedom of movement to these components after assembly, i.e., the components can no longer move freely relative to one another or with another, i.e., there is a form-fitting and/or force-locking fixation thereof. There is preferably no freedom of movement between the components.

A slight tolerance and/or a slight play between the components may be allowed, however. This play must be so minor that mechanical loads or other loads have no influence on the fixation and thus the functional efficiency of the components, i.e., there can be only minimal movement due to the play.

Another advantage of the proposed connecting area is that it can be used as a heat trap for the soldering process, in which a cable is fastened onto the HF plug element. Thus, the HF plug element does not heat up as much in the upper region during soldering.

Furthermore, in the first embodiment mentioned above, a portion of the interior of the through-opening of the mounting panel, e.g., an antenna cover, can be machined in by means of the fastening neck when the HF plug is inserted into the corresponding through-opening in the mounting panel. In other words, some of the material of the interior of the through-opening in the mounting panel, for example, an antenna cover, is cut off and/or abraded or deformed and/or pressed by insertion of and/or plugging into that part. This can take place by virtue of the fact that, for example, the fastening neck of the HF plug element and the mounting panel of the HF module and/or the through-opening is/are made of a material and a structure making this possible. It is important here that the structure is designed so that the HF plug element is secured in the through-opening after being secured without any play. In other words, what this means for the structure is that the structure of the fastening neck of the HF plug element should be different in at least partial areas than the structure of the interior of the through-opening. For example, the interior of the through-opening may be circular. Then the structure of the fastening neck of the HF plug element should not be completely circular but instead may have a polygonal shape, for example, a triangle, a pentagon or a hexagon. The fastening neck should at least have a region which is secured in conjunction with the interior of the through-opening in a form-fitting and/or force-locking manner, such that twisting or rotation of the HF plug element is difficult or impossible. The structure may have any type of complicated geometry but this is limited by the production process and the cost.

In one alternative embodiment having priority over the former, the mounting panel has a corresponding structure. The choice of whether the structure is provided in the interior of the through-opening of the mounting panel, e.g., an antenna cover, or is provided on the fastening neck of the HF plug element depends mainly on the manufacturing cost and the material of the mounting panel and the cost of providing the structure on the fastening neck. The mounting panel is preferably manufactured from a nonconducting material but it may also be made of a conductive material that has been treated to make it nonconductive. For example, it may be anodized or sheathed in a plastic.

Alternatively, a nonconductive insert may be introduced into the through-opening between the interior of the through-opening of the mounting panel and the fastening neck of the HF plug element. The insert must be fastened in such a way that it has a connection on both sides without any play, i.e., it does not slip on insertion and/or plugging in the HF element, and when forces act on it, it does not result in the HF plug element being able to move and/or wobble. An insert may be mounted on the fastening neck and also in the interior of the through-opening. In this application, it is important that the material can be worked, i.e., cut away and/or scraped away or deformed and/or pressed on insertion of the HF plug element.

It is up to the judgment of the user whether the HF plug element will have the structure or whether the structure will be in the interior of the through-opening of the mounting panel and will be removed, i.e., scraped off or deformed and/or pressed by insertion of the HF plug element.

In the second embodiment mentioned above, the fastening neck or the inside of the mounting panel does not necessarily have a structure as mentioned above. The flexible security element here mainly ensures the fixation of the components.

In another embodiment, an insertion aid which facilitates insertion of the HF element into the through-opening for the assembly person may be provided on the through-opening of the mounting panel. This insertion aid may be a notch or a protrusion which is adapted to the structure of the HF plug element in such a way that they engage in only one location on insertion and thus predetermine the alignment for insertion of the fastening neck into the through-opening.

In one embodiment, the HF plug element is first plugged into the mounting panel. For example, an antenna cover, i.e., from above and/or from the outside. The side that can be seen from the outside after the final assembly of the HF module, for example, an antenna, is referred to here as above, the top side or the outside. The side which cannot be seen from the outside after the final assembly of the HF module, for example, an antenna, is referred to here as below, the bottom side or the inside. In attaching the HF plug element from above, the fastening neck of the HF plug element is pushed through the through-opening in the mounting panel so that a connecting region on the lower side of the mounting panel protrudes outward and forms a space with the mounting panel into which the securing element is inserted. Plugging in the securing element may take place either from the side or by pushing it beyond the connecting region so that the HF plug element is gripped radially by the securing element.

With this type of fastening, it is first difficult to ensure that, after the final assembly, each bushing is provided with a securing element because this is no longer visible from the outside. To guarantee the proper quality assurance, in one embodiment of the invention a recess, for example, in the form of a hole is provided in addition, to each HF plug element in a suitable location in the mounting panel, for example, an antenna cover. Furthermore, it is advantageous then if the securing element is a color/, for example, red, yellow or any other signal color that can be seen clearly through the recess. Thus, it is possible by simple visual inspection to ensure that a securing element is mounted on each HF plug element in an antenna array.

In another embodiment, the HF plug element is pushed, i.e., inserted into the mounting panel from below. In this case, because of the geometry of the HF plug element the through-opening in the mounting panel must be larger than is the case when the fastening is done from above. It is advantageous here that the securing element is inserted from above through the connecting region onto the fastening neck of the HF plug element or from the side and is therefore visible after final assembly. Another advantage of this type of fastening is that an axial load directed upward is absorbed by the closing web on the HF plug element. Tensile forces act downward on the HF plug element due to the mounting of the antenna arrays in which the top side of the mounting panel, i.e., the antenna cover is facing downward. These tensile forces can be absorbed by the closing web mounted on the bottom side of the antenna cover, so that no additional securing element need be mounted on the bottom side of the antenna cover in this embodiment.

Securing Element

Another component of the HF plug connector according to the invention is a flexible securing element, which, because of its elastic properties, can be plugged onto and/or clamped in the connecting region by means of the fastening neck of the HF plug element. The securing element is designed as an elastic element, so that it can be inserted into and/or clamped onto the HF plug element in such a way as to form a prestress, by means of which fastening and/or fixation between the HF plug element and the securing element is achieved without any play. Due to this fastening without any play, the HF plug element cannot be moved by forces in the axial direction or by torsional forces and does not require any screw connections or any other aids in order to be secured. Furthermore, due to its prestress, differences in tolerance can be compensated in the thickness of the fastening neck of the HF plug element.

In one embodiment of the invention, the securing element may be attached and/or clamped to the fastening neck of the HF plug element from the side because of its elastic properties. In another embodiment the securing element can be pushed over the fastening neck of the HF plug element so that it clamps around the fastening neck from above. In another embodiment, the securing element is embodied in such a way that it has at least one spring arm.

The shape of the securing element depends on the type of fastening onto the HF plug element. For example, a securing element which is plugged from the side onto the fastening neck of the HF plug element may have a horseshoe shape. In such a shape, it is sufficient that one arm of the horseshoe is designed as a spring arm. However, the second arm may also be designed as a spring arm. One need only be sure that the securing element can be pushed over the HF plug element and that it is prestressed after being applied to the HF plug element so that play-free fixation can be achieved. To minimize the stresses occurring in certain locations, a web can be provided with such a shape on the side opposite the opening in the horseshoe. The point forces acting when the arms of the horseshoe-shaped securing element are pulled apart are distributed over a larger area and thus the risk of breakage is reduced. Furthermore, such a web offers the option of plugging the securing element onto the fastening neck with a greater force because of the greater acting area. Additionally or alternatively, the arms may be thinner toward the opening because then the force required to press the arms apart will be lower. To nevertheless ensure a good hold, the ends of the arms may in turn be thicker than the arms and/or spring arms themselves.

Another alternative is to provide a slope on the insides of the arms, i.e., in the regions facing into the interior of the horseshoe shape for fastening the securing element onto the HF plug connector. Due to the slope, the fastening need not take place edge on edge but instead the securing element can be pushed more easily over the fastening neck and/or clamp there.

A slope may be provided with each of the embodiments of the securing element, for example, even if the securing element is in the shape of a ring. Depending on the embodiment of the connected region of the HP plug element, the shape of the securing element can be adapted. In the choice of the design of the securing element it is important to be sure that the resulting connection between the securing element and the HF plug element is as free of play as possible.

For this embodiment of the invention, a horseshoe shape was described as an example. However, this shape is not limited to a horseshoe shape. Instead an essentially U-shaped form or other forms which have an opening in the periphery are also possible, so that they can be fastened onto the HF plug element from the side.

In addition, a securing element which is clamped from above over the connecting region must have the same properties as a securing element which is clamped onto the fastening neck from the side. However, no opening in the circumference of the securing element to push the securing element onto the HF plug element from above is necessary in this case. An annular securing element may be used, wherein the opening in the circular ring here serves as the opening for insertion of the securing element. If the securing element has such a ring shape, the total shape must have resilient properties in order to ensure expansion when the securing element is plugged onto it and contraction after being plugged onto it, so that a prestress and therefore a connection without any play is obtained. Therefore, in the choice of the material, attention must be paid to the fact that greater spring forces act here in pressing and/or pulling the form of the securing element apart.

In another embodiment, the securing element may be connected by a connecting web connected to one or more securing elements to be attached to neighboring HF plug connectors. The connecting web is preferably mounted between two securing elements and is designed so that it is longer than the connecting path between the HF plug connectors. In order to enable it to be introduced into the connecting path, it is preferably designed as an elastic connecting web or has a joint in this region, which is equipped to cause a kink in the connecting web in the starting condition so that the connecting web can be shortened and thus can be inserted into the connecting path. By pressing on the kink in the direction of the mounting panel, the connecting web is pressed downward so that the securing elements arranged at both ends of the connecting web are thus pressed with a certain tension onto the HF plug connector and can thus enter into a play-free connection. Alternatively, the connecting web may also be arranged in any other position, for example, parallel to the mounting plate or at an angle thereto, depending on the position in which the securing elements are mounted on the connecting web.

As security for the fact that the connecting web remains in the position, for example, another securing element may be attached to the joint. This securing element may be a pin with hooks on its bottom side, which is inserted through a through-bore in the mounting plate and thus clicks onto the back side by means of the hooks. However, other securing means may also be used. It is necessary only to ensure that a tight connection of the mounting plate is formed so that the connecting web cannot return to its starting position based on the tension applied to it and/or the securing elements are clicked out of the HF plug connectors.

To achieve a connection of more than two connecting webs, i.e., more than two securing elements, the connecting webs may be connected to one another crosswise, for example. This has the advantage that only one securing means need be used for four securing elements.

Due to the fitting selection of material of the securing element, an intermodulation-free connection is possible. Plastics that are as inexpensive as possible to produce, e.g., can be produced by injection-molding methods, can be used here. Examples here include PPSU (polyphenylsulfone), PEI (polyetherimide) or PFA (perfluoroalkoxy polymers). In the choice of the material for the securing element, one must mainly pay attention to the fact that the selected material is suitable for being provided with a prestress. In other words, when applied to the HF plug element, the securing element can be pulled apart and then would tend to contract automatically back into its initial shape, thereby encompassing the HF plug element without any play due to the fastening neck of the HF plug element. It must thus have a certain elasticity and strength. Furthermore, the material must be suitable for absorbing forces in the axial direction and absorbing tilting moments without thereby undergoing fatigue or breaking. In addition, the securing element may be designed in such a way that it can also absorb torque. Furthermore, the securing element should have a good thermal stability, where the requirements here may vary depending on the application. For example, heat which occurs due to losses can act on the securing element and the HF plug element. Although the securing element is nonconductive, it is also heated due to the resulting dissipation of power and the heating of the HF element. For this reason, the material must be able to withstand temperatures of approx. −50° C. to +130° C. or more without melting or breaking.

Any material having these properties can be used for the securing element. This material is preferably nonconductive. In the case when the material is conductive, it must have a sheathing or be treated to prevent intermodulation from occurring due to the securing element.

In another embodiment, the securing element may have mounting aids in one or more regions. These mounting aids may serve to pull apart the prestressed securing element by using a tool in order to push and/or snap it over the fastening neck of the HF plug element. At the same time, such a mounting aid may serve to attach a locking element to the securing element to additionally secure it.

With any embodiment, another locking element as described above may be mounted on at least one region of the securing element to achieve an additional securing effect. The locking element may be mounted on the securing element and in this way can prevent the securing element from snapping open. Such a means of locking the securing element may take place, for example, by means of a clamp with or without a wedge protruding into the opening of the securing element as the locking element which is applied in or on the mounting aids to prevent the securing element from snapping open. Alternatively, a catch element can be provided on the securing element that engages with a mating part that is arranged on the mounting panel after the securing element is put in place, thus preventing the securing element from rotating. The mating part can also be part of the mounting panel. Such a locking element may be a clamp, which is inserted into holes that serve as mounting elements. Alternatively or in addition, one or more catch elements can be provided which, in cooperation with a corresponding mating part arranged on the mounting panel, e.g., an antenna cover, can prevent the securing element from snapping open after it is put in place, with it also being possible for the mating part to be part of the mounting panel.

It can thus be seen that at least the following advantages are obtained with the mounting panel and the plug connection according to the invention:
No screw connections are necessary, so that rapid and easy mounting and dismantling are achieved.
A fastening without any play is made available.
A torsional load is absorbed at several locations and/or on several surfaces of the inserted fastening neck in the through-opening.
A load in the axial direction is absorbed by the securing element.
Differences in tolerance of the diameter of the HF plug element are compensated due to the prestress of the securing element.
An intermodulation-free connection can be established due to the choice of the material of the securing element.
A higher packing density of a plurality of HF plug elements on the mounting panel can also be implemented due to the compactness of the plug connection.
Furthermore, more usable area on the assembly wall is made available to apply labeling, for example, due to the compactness of the plug connection.
The least expensive production variant can be selected due to the variable attachment of the structure on the fastening neck of the HF plug element or the interior of the through-opening in the mounting panel.

Additional features and advantages of the invention not described above are derived from the following description of exemplary embodiments of the invention on the basis of the figures in the drawings, which show the details of the invention and from the claims. The individual features may be implemented individually alone or several together in any combination in a variant of the invention.

Preferred embodiments of the invention are explained in greater detail below on the basis of the accompanying drawings. Basically one or two of the arms of the securing elements illustrated in the figures may be designed as spring arms. In the drawings:

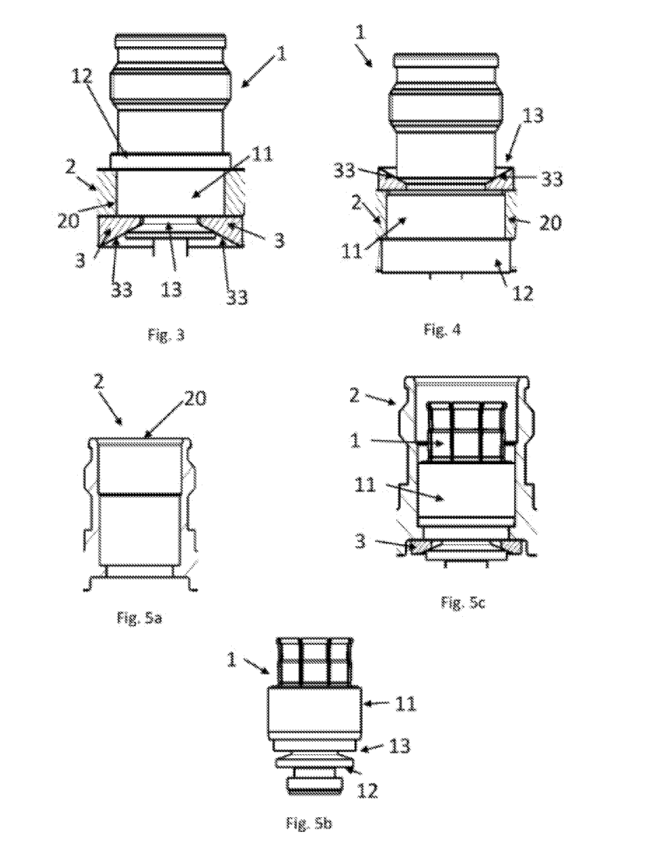

FIG. 3 shows a sectional view through an HF plug connector according to one embodiment of the present invention.

FIG. 4 shows a sectional view through an HF plug connector according to an alternative embodiment of the present invention.

FIGS. 5a through 5c show a side view of an HF plug connector according to another alternative embodiment of the present invention.

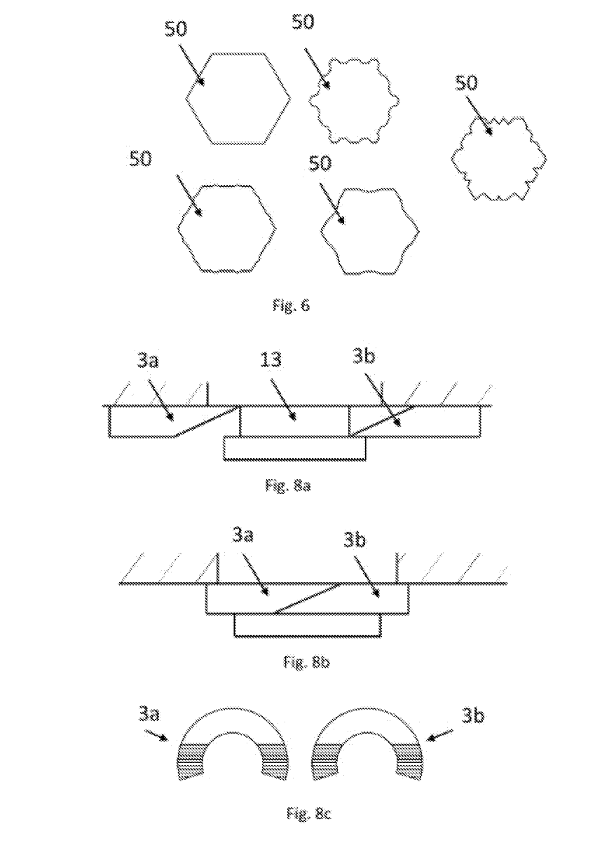

FIG. 6 shows examples of sectional views of a structure of the fastening neck or of the interior of the through-opening in the mounting panel, i.e., an antenna cover here, according to different embodiments of the present invention.

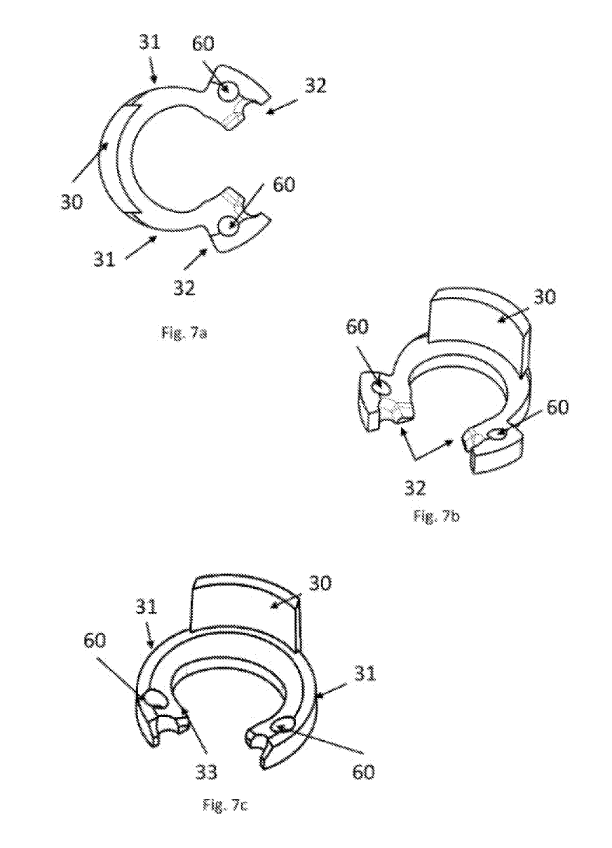

FIG. 7a shows a top view of a securing element of an HF plug connector according to one embodiment of the present invention.

FIG. 7b shows a view of a securing element of an HF plug connector according to another embodiment of the present invention.

FIG. 7c shows a view of a securing element of an HF plug connector according to another embodiment of the present invention.

FIGS. 8a to 8c show a diagram of a securing element comprised of two parts with oblique sloping edges mounted on an HF plug connector according to an additional embodiment of the present invention.

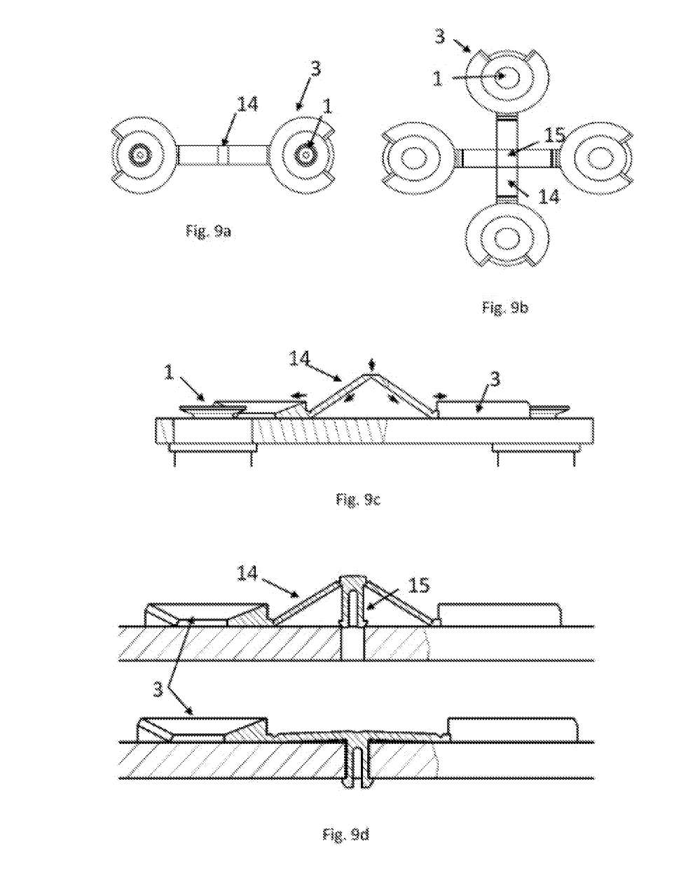

FIGS. 9a to 9d show views of a plurality of securing elements attached to a connecting web according to one embodiment of the present invention.

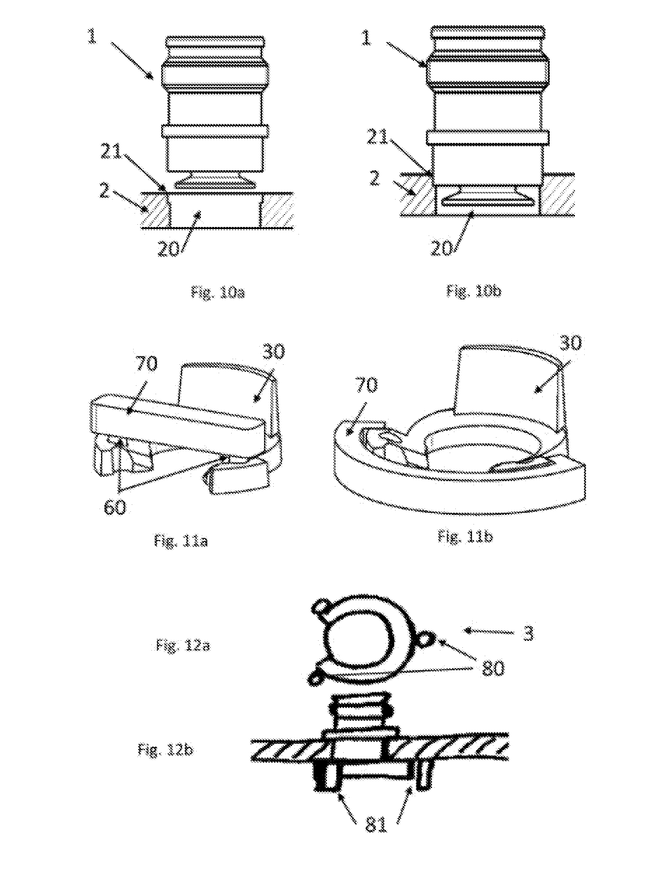

FIGS. 10a and 10b each show a view of an insertion aid according to one embodiment of the present invention.

FIGS. 11a and 11b each show views of locking elements that can be attached to the securing element according to various embodiments of the present invention.

FIGS. 12a and 12b each show a view of a catch element and a corresponding mating part according to one embodiment of the present invention.

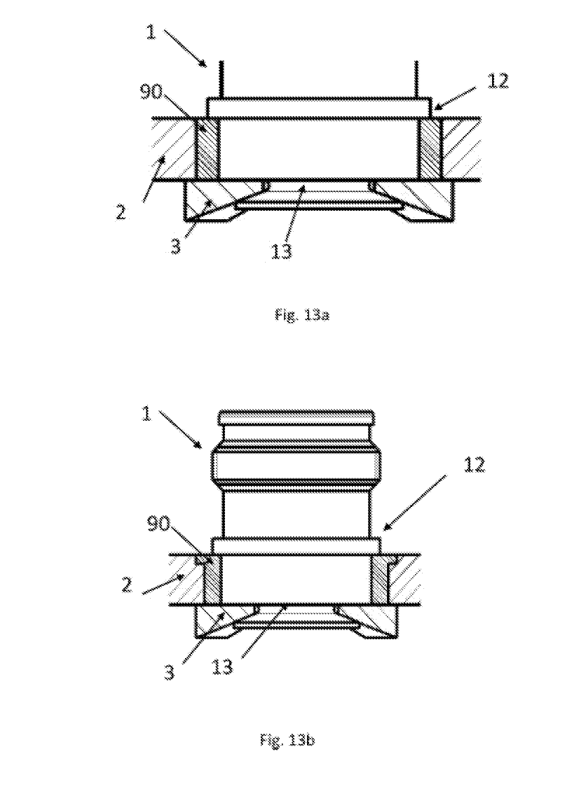

FIGS. 13a and 13b each show a view of two alternatives of an insert arranged in the through-opening according to one embodiment of the present invention.

In the following descriptions of figures, the same elements and/or functions are labeled with the same reference numerals.

FIGS. 3 and 4 each show sectional views of different basic embodiments of HF plug connectors according to the invention. These figures each show an HF bushing 1, which serves as an HF plug element and whose fastening neck 11 is inserted into a through-opening 20 in a mounting panel, shown here as an antenna cover 2, as far as the stop on the closing web 12. To attach the securing element 3 to the HF bushing 1, the HF bushings 1 of both embodiments have a connecting region 13 which makes it possible to click on the securing element 3 so that it cannot slip in the axial direction. In both FIGS. 3 and 4 the securing element 3 is shown with sloping edges 33 because the best surface pressure is obtained in this way and thus the least freedom from play. The shape of the securing element 3 can be adapted to the shape of the connecting region 13. It is important for the securing element 3 to be mountable in the connecting region 13 of the HF bushing 1 so that a movement of the HF bushing in the axial direction, i.e., out of the antenna cover and also a torsion, i.e., a rotation of the bushing in the antenna cover are impossible, i.e., a play-free connection between the HF bushing and the antenna cover 2 is achieved.

The HF bushings 1 shown in FIGS. 3 and 4 differ in that the HF bushing 1 shown in FIG. 3 is plugged into the antenna cover 2 from above. However, the HF bushing 1 shown in FIG. 4 is inserted into the antenna cover 2 from beneath, which has the effect that the closing web 12 prevents the HF bushing 1 from slipping out when there are axial forces acting in the direction of the top side of the cover. This advantage can be utilized in particular when, after final assembly, the top side of the antenna cover 2 is directed downward, so that the weight of an attached cable alone exerts an axial force downward on the HF bushing 1.

The two embodiments also differ in that the securing element 3 according to the invention shown in FIG. 3 is arranged on the side of the antenna cover 2 which is no longer visible from the outside after final assembly. However, the securing element 3 according to the invention of the embodiment shown in FIG. 4 is visible on the outside and/or top side of the antenna cover 2 after final assembly.

Furthermore, depending on the embodiment, the securing element 3 cannot be plugged onto the fastening neck 11 from the side, but instead this must be done from above (not shown in the figures). To do so, the securing element is preferably ring-shaped with an opening on its top side to keep the bushing free and/or to be able to attach it from above. Furthermore, it is embodied such that, on its underside with which it is clamped on the connecting region 13 of the HF plug element 1, it has a shape which represents a means of securing the HF plug element 1 against axial movement and rotational movement, thereby achieving a connection without any play. In this embodiment, the material of the securing element 3 must have elastic properties in particular because it must be stretched greatly in order to be able to push it over the plug element. However, it must also have the property of being able to return to its initial shape in order to fulfill the desired holding properties. This embodiment of the securing element 3 is preferably selected when the variant of the HF plug connector shown in FIG. 4 is used, i.e., the securing element 3 is visible after the final assembly. In addition, to the required elasticity, it is important here in choosing the material for the securing element that it should have a certain weather fastness because in this embodiment it is mounted on the outside and is therefore exposed to a wide variety of weather conditions, such as ice, hail, UV light or water. When the variant illustrated in FIG. 3 is chosen, the securing element 3 must be attached to the fastening neck 11 before other connections are attached to the lower side of the HF plug element 1, e.g., cable.

FIGS. 5a to 5c show an alternative embodiment of the HF plug connector according to the invention. Here, the HF plug element is not an HF bushing, but instead is only the electric module that is normally situated in the interior of the mechanical module of the HF bushing (see FIG. 5b). The mechanical module is formed so that it is already secured in the mounting panel 2 of the HF module, i.e., for example, the antenna, so it has an integral, i.e., one-piece, design and can be overmolded with a nonconductive material such as a plastic. This is illustrated in FIG. 5a. The electric module 1, for example, is inserted into the mounting panel combination shown in FIG. 5a and is secured with the securing element 3 according to the invention, as shown in FIG. 5c, for example, at least the internal and external conductors of the antenna. As illustrated in FIGS. 3 and 4, the arrangement of the HF plug element may be at the top or at the bottom. This depends on how the mounting panel combination has been manufactured.

FIG. 6 shows examples of sectional views of a structure 50 of the fastening neck 11 and/or of the interior of the through-opening 20 in the mounting panel of the HF module 2 according to different embodiments of the present invention. As described above, both the fastening neck 11 and the inside of the through-opening 20 in the mounting panel of the HF module 2 may have a structure 50 to permit fastening of the HF plug element 1 on the mounting panel 2 of the HF module 2 without any play.

For example, the structure may be designed as a hexagon, which shapes the interior of the through-opening 20 on insertion into the through-opening 20 so that material is removed and/or scraped or deformed and/or pressed away from the opening. If the structure 50 is attached to the fastening neck 11, then the structure 50 scrapes off a portion of the inside of the through-opening 20 in the mounting panel of the HF module 2. If the through-opening 20 has the structure 50, then a portion thereof is removed and/or scraped off or deformed and/or pressed by the insertion of the fastening neck 11 because this portion has a shape ensuring that it will remove and/or scrape off a portion of the structure 50 of the through-opening. In other words, the fastening neck must have a diameter at least slightly larger than the diameter of the through-opening 30. In both types of mounting of the structure 50, it is ensured that a connection is formed between the HF plug element 1 and the mounting panel of the HF module 2 without any play.

Additional examples of structures 50 according to the invention, which meet the requirements defined above, are also shown in FIG. 6. FIG. 6 shows only examples of structures. Any other conceivable structure could be used instead of those shown here. These structures 50 may be used alone or in any combination. For example, this shows structures 50 in the form of a zigzag line, a trapezoid, a semicircle, a rectangle or a square. If recesses and/or elevations are preferably arranged in the fastening neck 11 and/or the inside of the through-opening 20, any shapes, including complementary shapes, may be used as the structures which permit a connection between the HF plug element 1 and the mounting panel of the HF module 2 without any play as a result of removal and/or scraping or deformation and/or pressing. Alternatively, the mounting panel of the HF module 2 may have an inclined contour which creates an axial prestress on the HF plug element by way of the securing element.

All the structures 50 shown here may be arranged on the fastening neck 11 or on the inside of the through-opening 20. The decision as to where this structure 50 will be arranged depends on factors such as the cost of manufacturing, the ease of manufacturing or the material and is made by the skilled person in accordance with the desired application.

FIG. 7a shows a top view of a securing element 3 of an HF plug connector according to one embodiment of the present invention. In this embodiment, the securing element 3 is embodied in the form of a horseshoe having a web 30 on the side and/or in the region opposite the opening. This web serves to distribute over a larger are the forces aₘₐₓ, which act in spots in the area where the web 30 is mounted, when the two spring legs 31 are pulled apart and/or bent separately. In addition, the securing element 3 in FIG. 7a has an area, where the arms 31 are made wider at the respective ends pointing toward the opening. This has the advantage that, in this way, the area for clicking and/or clamping is larger and therefore a greater holding force can be exerted on the fastening neck 11 of the HF bushing. In the example of the securing element 3 shown here, one or both arms may serve as spring arms.

In addition, the securing element 3 also has mounting aids 60, which are mounted on the widened area 32 of the arms 31. The mounting aids 60 here are holes through the opening of which a suitable tool can be inserted to facilitate the separation of the arms 31. In addition, these holes may serve to hold a locking element. Examples of locking elements are shown in FIGS. 11a and 11b. The shape of the locking element is adapted to the shape of the widened area 32 in the arms 31 and/or the type of opening. In the case of the securing element shown here, one or both arms may function as spring arms.

FIG. 7b shows a perspective view of a securing element 3 of an HF plug connector according to FIG. 7a, where the securing element 3 is designed in the form of a horseshoe with a web 30 on the side opposite the opening, as in the preceding embodiments. In addition, the securing element 3 has sloping edges 33 in the regions of the arms 31 facing into the interior of the horseshoe, thereby allowing a simple means of clicking the securing element 3 in place. In the case of the securing element shown here, one or both arms may serve as spring arms.

FIG. 7c shows a perspective view of an alternative embodiment of a securing element 3 of an HF plug connector according to the present invention where the securing element 3 is designed in the form of a horseshoe with a web 30 on the side opposite the opening as in the preceding embodiments. Here again, the securing element 3 has edges 33, which have a slope in the regions of the arms 31 facing into the interior of the horseshoe shape, enabling simple clicking of the securing element 3 in place. In the case of the securing element not shown here, one or both arms may function as spring arms. The securing element 3 of this embodiment also has holes as mounting aids 60 but does not have a widened area of the arms 31 as in the exemplary embodiments in FIGS. 7a and 7b.

FIGS. 8a to 8c show views of a securing element 3, which is mounted on the HF plug element 1. It consists of two parts 3a and 3b and has stepped and/or sawtooth sloping edges for the sake of illustration. The sloping, stepped and/or sawtooth edges make it easier for the parts 3a and 3b of the securing element to be upright, because the attachment cannot be done edge-on-edge, which would cause greater friction. The two parts 3a and 3b of the securing element are plugged onto the connecting neck 13 from two sides and lock together when attached in this way, so that a ring is formed around the connecting neck 13. Sloping edges may also be used on securing elements without an opening, these being secured on the HF plug element 1 from above, for example (not shown). With the securing element shown here, one or both arms may serve as spring arms.

FIGS. 9a to FIG. 9d each show views of several securing elements 3 connected to a connecting web 14. FIGS. 9a and 9b each show a top view onto two and/or four securing elements connected to one another by means of connecting webs 14. FIG. 9c shows how the connecting web 14 forms a kink to be inserted into the connecting path between two HF plug elements 1. By pressing on the kink, the two arms of the connecting web 14 and the securing elements 3 arranged on the two ends of the connecting web 14 click into the respective HF plug connectors 1. FIG. 9d shows a schematic of an additional securing means 15, which is embodied as a pin with a barbed hook in this case. The pin is inserted into a through-hole in the mounting panel and clicks with its barbed hook on the rear side of the mounting panel 2. The additional securing means 15 ensures that a secure connection to the mounting panel is achieved, so that the connecting web cannot return to its initial position as a result of the tension applied to it and the securing elements cannot snap out of the HF plug connectors.

FIGS. 10a and 10b each show a view of an insertion aid 21 for an HF module. The insertion aid 21 is a defined structure that is arranged on the fastening neck 11 and on a region close to, directly on, or in the through-opening 20 in the mounting panel of the HF module 2 according to the lock and key principle. The insertion aid 21 serves to facilitate the insertion of the HF plug element 1 into the mounting panel of the HF module 2 and/or to predetermine the alignment for the assembly of the HF plug element 1. The insertion aid 21 in FIGS. 10a and 10b is designed as a recess directly in the through-opening 20, the diameter of the recess corresponding to the diameter of the fastening neck 11. The HF plug element, illustrated here as an HF bushing 1, can thus be prepositioned in the opening in such a way that the HF bushing 1 must be pressed or driven into the through-opening 20 in a subsequent assembly step, for example. Such an insertion aid may be necessary, for example, when the components are to be prepositioned for assembly. It may also be the case that a predetermined assembly sequence must be followed, so that the HF plug element and/or the HF bushing can be assembled because of the insertion aid 21 only in a certain predetermined assembly step. An insertion aid 21 may also be provided for reasons of space, namely when the space around the HF plug element, for example, is not sufficient to insert a positioning tool. The HF plug element can nevertheless be assembled in the correct position by means of the insertion aid 21.

FIGS. 11a and 11b show views of locking elements 70 as examples that can be mounted on the securing element 3. FIG. 11a shows a clamp and/or bar that is inserted at the ends of the arms 31 into the assembly aids 60, which is a hole in each case here. This clamp may additionally be provided with a filling web (not shown) which fills up the opening of the securing element 3 and thus ensures additional stability. FIG. 11b shows a clamp placed on the arms 31 from the side of the opening of the securing element, wherein the clamp clicks into the widened area of the arms 31 and thus provides an additional means of securing them to prevent the securing element being from falling off. In an alternative embodiment of the locking element 70 (not shown), a ring may be arranged out the securing element 3, holding it in its shape or even exerting a force on it, further compressing the securing element 3.

FIGS. 12a and 12b each show a view of a catch element 80 and a corresponding mating part 81 according to one embodiment of the present invention. FIG. 12a shows a catch element 80 arranged on the securing element 3 according to one embodiment of the present invention. The catch element 80 is arranged, for example, on the ends of the arms and/or spring arms 31 for opening the securing element 3. FIG. 12b shows a mating part 81 arranged on the mounting panel of the HF module 2 corresponding to the catch element 80 shown in FIG. 12a, which serves to ensure that the securing element 3 is locked onto the mating part 81 after being attached thereto, so that it can no longer rotate. FIGS. 12a and 12b illustrate such a catch element 80 and the mating part 81. However, the only shapes that can be used are shapes that are suitable for fulfilling the object define above.

FIG. 13a and FIG. 13b show two alternatives of a nonconductive insert 90, which is arranged in the through-opening 20 in the mounting panel of the HF module 2 and is described in the introduction. The insert 90 may either be fastened in the through-opening 20 or it may be arranged on the fastening neck 11 and pushed with it into the through-opening. In both cases, the insert 90 must have a structure 50, which is cut and/or scraped away or deformed and/or pressed on insertion into the through-opening 20. This is due to the fact that given the need to use an insert 90, both the mounting panel of the HF module 2 and the HF plug element 1 are made of a conductive material, wherein removal and/or scraping or deformation and/or pressing of the structure would be very difficult to accomplish. The insert is shaped in such a way that it prevents conductive connections between the mounting panel and the HF plug element as illustrated in the alternatives shown in FIGS. 13a and 13b.

From the description of the invention, it can be concluded that in particular with respect to the structure used, there are many degrees of freedom for implementing the principle of the invention. For this reason, not all alternatives can be described but they nevertheless still fall within the scope of protection of this invention. The individual features described may be combined with one another in order to comply with the safety requirements required for the desired application.

### LIST OF REFERENCE SYMBOLS

1 HF bushing and/or HF plug element
11 fastening neck
12 closing web
13 connecting region
14 connecting web
15 additional securing means
2 mounting panel, e.g., antenna cover
20 through-opening
21 insertion aid
3 securing element
3a, 3b part 1 and part 2 of a securing element
30 web
31 spring arms
32 widened area of the spring arms at the opening
33 sloping edges
300 nut
400 mounting plate
401 screws
50 structure
60 mounting aid
70 locking element
80 catch element
81 mating part to the catch element
90 nonconductive insert

1.-27. (canceled)

28. An HF module having a mounting panel (2) and at least one HF plug element (1) with a fastening neck (11) inserted into a through-opening (20) arranged on the mounting panel (2) for each HF plug element (1), and for each HF plug element (1), at least one securing element (3) designed as a flexible element is plugged onto a connecting region (13) of the HF plug element (1) adjacent to the fastening neck (11), wherein a region of the securing element (3) facing the HF plug element (1) has a slope (33), and wherein the region of the connecting region (13) facing the securing element (3) has a corresponding slope to secure the HF element (1) on the mounting panel (2) without any play due to the prestress on the securing element (3).

29. The HF module according to claim 1, wherein the securing element (3) is designed in the form of a ring.

30. The HF module according to claim 1, wherein the securing element (3) has a peripheral opening for lateral attachment and at least one spring arm (31).

31. The HF module according to claim 3, wherein a web (30) is attached to the region opposite the peripheral opening.

32. The HF module according to claim 3, wherein each of the spring arms (31) is thinner toward the peripheral opening, or wherein each of the spring arms (31) becomes thinner up to the region of its open end toward the peripheral opening and becomes thicker again in the region of the open end.

33. The HF module according to claim 4, wherein each open end of each one of the spring arms (31) is thicker than the respective remaining spring arm (31), or wherein each of the spring arms (31) becomes thinner up to the region of its open end toward the peripheral opening and becomes thicker again in the region of the open end

34. The HF module according to claim 3, wherein the securing element (3) has two spring arms (31), a locking element (70) being arranged on their open ends to prevent the securing element (3) from becoming unsnapped.

35. The HF module according claim 1, wherein at least one region of the securing element (3) has a mounting aid (60).

36. The HF module according to claim 1, wherein a securing element (3) is connected to one or more other securing elements (3) by means of a flexible connecting web (14) attached thereto, wherein a plurality of connecting elements (14) can also be connected crosswise to the respective securing elements (3).

37. The HF module according claim 1, wherein the fastening neck (11) of the HF plug element (1) and/or the through-opening (20) has/have a structure (50), wherein some of the material on the through-opening (20) is cut away or deformed when the fastening neck (11) is inserted into the through-opening (20).

38. The HF module according to claim 11, wherein the structure (50) has at least one flattened or sloping region.

39. The HF module according to claim 11, wherein the structure (50) is a polygon, in particular a triangle or a pentagon or a hexagon.

40. The HF module according to claim 11, wherein the structure (50) has at least one region with elevations and recesses.

41. The HF module according to claim 14, wherein the elevations and recesses are in the form of grooves, triangles, squares, trapezoids, semicircles or a combination thereof.

42. The HF module claim 1, wherein the mounting panel (2) has a recess in a region near the through-opening (20), said recess being positioned in such a way that a securing element (3) attached to the connecting region (13) is visible on the other side of the mounting panel (2).

43. The HF module according to claim 1, wherein the at least one HF plug element (1) is an HF bushing.

44. The HF module according to claim 1, wherein the mounting panel (2) is an antenna cover.

45. The HF module according to claim 4, wherein the securing element (3) has two spring arms (31), a locking element (70) being arranged on their open ends to prevent the securing element (3) from becoming unsnapped.

46. The HF module according to claim 5, wherein the securing element (3) has two spring arms (31), a locking element (70) being arranged on their open ends to prevent the securing element (3) from becoming unsnapped.

47. The HF module according to claim 6, wherein the securing element (3) has two spring arms (31), a locking element (70) being arranged on their open ends to prevent the securing element (3) from becoming unsnapped.
